(19) United States
(12) Patent Application Publication
(10) Pub. No.: US 2026/0163924 A1
(43) Pub. Date: Jun. 11, 2026

(54) DEVICE AND METHOD FOR CONFIGURING A VOICE CHANNEL IN FTTDP

(71) Applicant: Netcomm Wireless PTY LTD, Lane Cove, NSW (AU)

(72) Inventors: Peter Eccles, Lane Cove (AU); Kenneth Green, Lane Cove (AU); Adrian Macarthur-King, Lane Cove (AU)

(73) Assignee: NetComm Wireless Pty Ltd, Lane Cove (AU)

(21) Appl. No.: 18/707,576

(22) PCT Filed: Nov. 4, 2022
(86) PCT No.: PCT/AU2022/051327

§ 371 Date: May 4, 2024

(30) Foreign Application Priority Data
Nov. 5, 2021 (AU) 2021903543

(51) Int. Cl. H04L 65/1069; H04L 41/0823; H04L 41/0895; H04L 65/1104

(52) U.S. Cl. CPC H04L 65/1069; H04L 41/0823; H04L 41/0895; H04L 65/1104

(57) ABSTRACT

A Distribution Point Unit (DPU) communicating voice configuration data between Element Management System, Fibre to the Home network (FTTH EMS) and one or more ATA modules within a Fibre to the Distribution Point (FTTdp) network, wherein a processor interfaced with an optical network controller, an electrical network controller, and the memory; the processor presents to the FTTH EMS, the DPU as an Optical Network Terminal (ONT) of a FTTH network; the processor maintains in a memory one or more virtual voice ports; each virtual voice port is mappable to one of electrical ports, and the processor informs the FTTH EMS, via the FTTH control protocol, a distinct voice port for each virtual voice ports; maintain a mapping between the virtual voice ports and the electrical ports; receive a voice configuration message and a corresponding voice port identifier according to the FTTH control protocol and identify corresponding virtual voice port; determine a particular electrical port associated with identified virtual voice port based on mapping; communicate the voice configuration message to an NTD associated with the determined electrical port.

### FIELD OF THE INVENTION

The present invention generally relates to configuring Voice over Internet Protocol (VoIP) services for Fibre to the Distribution Point (FTTdp).

### BACKGROUND TO THE INVENTION

It is known to provide voice services over a Fibre to the Distribution Point (FTTdp) broadband network infrastructure by having a router or other residential gateway (RG) interface with an Analog Telephone Adaptor (ATA)—for example, the ATA may be a function provided by the router or RG or may be a standalone device on a local network associated with the RG. In an example of FTTdp, an optical data connection terminates near, but not at, a location (such as a residence) to be provided Internet service (such as at the street outside the premises). The final distance utilises electrical data communication over existing wiring, for example, over a twisted copper pair.

In FTTdp, a distribution point unit (DPU) is provided at the termination point of the optical data connection. The DPU is typically connected to one or more network termination devices (NTDs) via separate electrical wiring—thus, the DPU is configured to distribute incoming data to the correct NTD and return outgoing, whereas the optical data connection is configured to communicate with the DPU. RGs are interfaced with network termination devices (NTD)—in this way, the NTD is the termination point of the broadband network at the residence.

It may be up to the owner of the ATA to provide configuration data in order to allow the ATA to operate over the Internet (e.g. to receive and make calls using a particular telephone number). Alternatively, it is known for an Internet Service Provider (ISP) or internet telephony provider to have a capability to directly configure the ATA—this may be through an Element Management System (EMS) provided specifically for this purpose. For example, the RG may be configured to directly receive configuration commands from the EMS. In this arrangement, the RG is registered with the EMS and is addressable as an Internet device (e.g. via an IP address and port number). The ATA effectively constitutes an addressable device on the Internet (whether directly or behind a NAT) once configured.

Similarly, it is also known to provide voice services over a Fibre to the House (FTTH) broadband network infrastructure by having an optical network terminal (ONT), located at the end-point (e.g. the residence) of an optical data connection and directly interfaced with an Analog Telephone Adaptor (ATA)—usually, the ATA function is provided by the ONT. In this arrangement, the ONT is configurable by an Element Management System (EMS) associated with the FTTH network. In this topology, each ONT is directly visible to the EMS of the FTTH.

However, presently, an EMS configured for controlling voice services at an ONT within a FTTH network is not suited for controlling voice services at a NTD of a FTTdp network. For example, the NTD is not directly visible to the EMS because it is behind a DPU and, in any event, the NTDs may not be compatible with the EMS of the FTTH.

It is against this background and the problems and difficulties associated therewith that the present invention has been developed.

### SUMMARY OF THE INVENTION

According to an aspect of the present invention, there is provided a Distribution Point Unit (DPU) for facilitating communication of voice configuration data between an Element Management System configured for a Fibre to the Home network (FTTH EMS) and one or more ATA modules within a Fibre to the Distribution Point (FTTdp) network, the DPU comprising: an optical network processor configured for data communication with an optical network via an optical port; an electrical network processor comprising one or more of electrical ports for data communication, each electrical port configured for coupling to a separate electrical line, wherein said data communication, for each electrical port, is with a corresponding Network Termination Device (NTD) associated with the particular electrical line; a memory; and a processor operable interfaced with the optical network processor, the electrical network processor, and the memory, wherein the processor is configured to: undertake data communication with the FTTH EMS via the optical port according to an FTTH control protocol, wherein the processor is configured to present, to the FTTH EMS, the DPU as an Optical Network Terminal (ONT) of a FTTH network, wherein the processor maintains in the memory one or more of virtual voice ports, wherein each virtual voice port is mappable to one of the electrical ports, and wherein the processor informs the FTTH EMS, via the FTTH control protocol, that it has a distinct voice port for each of its virtual voice ports; maintain a mapping between the virtual voice ports and the electrical ports; receive a voice configuration message and a corresponding voice port identifier according to the FTTH control protocol and identify the corresponding virtual voice port; determine a particular one of the electrical ports associated with the identified virtual voice port according to the mapping; and communicate the voice configuration message to the NTD associated with the determined electrical port.

In an embodiment, the DPU comprises a plurality of electrical ports and a plurality of virtual voice ports. This embodiment may provide an advantage of enabling a single DPU to provide voice services to multiple premises without requiring modification to the Element Management System of a Fibre to the Home network.

The optical network may be a Passive Optical Network (PON). The FTTH control protocol may comprise the ONU Management Control Interface (OMCI). Each electrical port may be configured for communicating with its associated NTD according to a Digital Subscriber Line protocol, such as VDSL, VDSL2, G.Fast, or G.mgfast.

The mapping between virtual voice ports and the electrical ports may be predefined in memory. Alternatively, the mapping may be dynamically updated such that a new mapping between a particular virtual voice port and a particular electrical port is made when required, such as when a new NTD is connected to said particular electrical port. The mapping may provide a one-to-one relationship between the virtual voice port(s) and the electrical port(s) or, alternatively, the DPU may be enabled to map one or more virtual voice ports to the, or each, electrical port.

The processor may be configured to convert the voice configuration message to another protocol, different to the FTTH control protocol, before communicating the voice configuration message to the associated NTD.

The voice configuration message may comprise Session Initiation Protocol (SIP) information.

The processor may be further configured to: receive a voice configuration response from the NTD; and communicate the voice configuration response to the FTTH EMS according to the FTTH control protocol with data identifying a voice port corresponding to the virtual voice port mapped to the electrical port associated with the particular NTD.

The processor may be further configured to: receive a status request message and a corresponding voice port identifier from the FTTH EMS and identifying the corresponding virtual voice port; determining a particular one of the electrical ports associated with the identified virtual voice port according to the mapping; and communicating the status request message to the NTD associated with the determined electrical port.

The processor may be further configured to: receive a status response message from an NTD to which a status request message has been communicated, the status response message in response to the status request message; and communicate the status response message to the FTTH EMS according to the FTTH control protocol with data identifying a voice port corresponding to the virtual voice port mapped to the electrical port associated with the particular NTD.

According to another aspect of the present invention, there is provided a network system comprising a DPU according to the above aspect, and further comprising: one or more NTDs each coupled, via separate electrical lines, to a unique one of the electrical ports of the DPU.

Each NTD may be interfaced with at least one ATA modules and each NTD may be configured to: provide received voice configuration messages to its at least one interfaced ATA module, thereby causing the, or each, ATA module to be configured according to the voice configuration message. Each NTD may be further configured to: determine and communicate a status response message, based on information generated by the, or each, interfaced ATA module, in response to receiving a status request message. At least one NTD may comprise: at least one ATA module as a logical component; and a physical analogue telephony port for the, or each, ATA module.

Received voice configuration messages and other received communications may comprise, in a case where a NTD comprises multiple interfaced ATA modules, a port indication being information enabling the NTD to determine which of its interfaced ATA modules is the intended target of the particular communications.

Each NTD may be interfaced with one ATA module. Alternatively, each NTD may be interfaced with a plurality of ATA modules, such that each NTD is interfaced with the same number of ATA modules, and the DPU may be preconfigured such as to associate groupings of virtual voice ports with each NTD, each group comprising a number of virtual voice ports equal to the number of ATA modules interfaced with each NTD. In another alternative, each NTD may be interfaced with one or more ATA modules and may be configured to inform the DPU of its number of interfaced ATA modules, and the DPU may be configured to, in response, map a grouping comprising a corresponding number virtual voice ports to the particular NTD. The DPU may be configured to include in communications (such as voice configuration messages) to a particular NTD a port indication identifying a particular ATA module of the NTD for receiving said communications. Each NTD may be configured to include in communications (such as voice configuration responses) to the DPU a virtual voice port indication identifying a particular virtual voice port for receiving said communications.

According to another aspect of the present invention, there is provided an aggregate network system comprising a plurality of network systems, each as per the previous aspect, wherein the DPUs of each network system are in data communication with the same FTTH EMS.

Optionally, the network system or aggregate network system further comprises the FTTH EMS.

According to yet another aspect of the present invention, there is provided a method for facilitating communication of voice configuration data between an Element Management System configured for a Fibre to the Home network (FTTH EMS) and one or more ATA modules within a Fibre to the Distribution Point (FTTdp) network, the method comprising: undertaking data communication with the FTTH EMS via an optical data line according to an FTTH control protocol, including presenting, to the FTTH EMS, a Distribution Point Unit (DPU) as an Optical Network Terminal (ONT) of the FTTH network, maintaining one or more of virtual voice ports, wherein each virtual voice port is mappable to one of one or more of electrical ports of the DPU, including informing the FTTH EMS, via the FTTH control protocol, that the DPU has a distinct voice port for each of its virtual voice ports; maintaining a mapping between the virtual ports and the electrical ports; receiving a voice configuration message and a corresponding voice port identifier according to the FTTH control protocol at the DPU and identifying the corresponding virtual voice port; determining a particular one of the electrical ports associated with the identified virtual voice port according to the mapping; and communicating the voice configuration message to an Network Termination Device (NTD) associated with the determined electrical port.

In an embodiment, the DPU comprises a plurality of electrical ports and the method comprises maintaining a plurality of virtual voice ports. This embodiment may provide an advantage of enabling a single DPU to provide voice services to multiple premises without requiring modification to the Element Management System of a Fibre to the Home network.

The optical network may be a Passive Optical Network (PON). The FTTH control protocol may comprise the ONU Management Control Interface (OMCI). Each electrical port may be configured for communicating with its associated NTD according to a Digital Subscriber Line protocol, such as VDSL, VDSL2, G.Fast, or G.mgfast.

The mapping between virtual voice ports and the electrical ports may be predefined in a memory of the DPU. Alternatively, the mapping may be dynamically updated such that a new mapping between a particular virtual voice port and a particular electrical port is made when required, such as when a new NTD is connected to said particular electrical port. The mapping may provide a one-to-one relationship between the virtual voice port(s) and the electrical port(s) or, alternatively, the DPU may be enabled to map one or more virtual voice ports to the, or each, electrical port.

The voice configuration message may be communicated to the associated NTD using the FTTH control protocol. Alternatively, the method may further comprise converting the voice configuration message to another protocol, different to the FTTH control protocol, before communicating the voice configuration message to the associated NTD.

The voice configuration message may comprise Session Initiation Protocol (SIP) information.

The method may further comprise the steps of: receiving, at the DPU, a voice configuration response from the NTD; and communicating the voice configuration response to the FTTH EMS according to the FTTH control protocol with data identifying a voice port corresponding to the virtual voice port mapped to the electrical port associated with the particular NTD.

The method may further comprise the steps of: receiving, at the DPU, a status request message and a corresponding voice port identifier from the FTTH EMS and identifying the corresponding virtual voice port; determining a particular one of the electrical ports associated with the identified virtual voice port according to the mapping; and communicating the status request message to a NTD associated with the determined electrical port.

The method may further comprise the steps of: receiving a status response message from an NTD to which a status request message has been communicated, the status response message in response to the status request message; and communicating the status response message to the FTTH EMS according to the FTTH control protocol with data identifying a voice port corresponding to the virtual voice port mapped to the electrical port associated with the particular NTD.

The method may further comprise the step of: coupling an NTD to at least one electrical port of the DPU.

Each NTD may be interfaced with at least one ATA module, and the method may further comprise the step of: providing, by an NTD, received voice configuration messages to its interfaced at least one ATA modules, thereby causing the, or each, ATA module to be configured according to the voice configuration message. The method may further comprise the step of: at an NTD, determining and communicating a status response message, based on information generated by its interfaced the, or each, ATA module, in response to receiving a status request message. Each NTD may comprise: at least one ATA module as a logical component; and a physical analogue telephony port controlled by the at least one logical ATA module.

Each NTD may be interfaced with one ATA module. Alternatively, each NTD may be interfaced with a plurality of ATA modules, such that each NTD is interfaced with the same number of ATA modules, and the DPU may be preconfigured such as to associate groupings of virtual voice ports with each NTD, each group comprising a number of virtual voice ports equal to the number of ATA modules interfaced with each NTD. In another alternative, each NTD may be interfaced with one or more ATA modules and the method may further comprise the steps of: at an NTD, informing the DPU of its number of interfaced ATA modules; and in response, the DPU mapping a grouping comprising a corresponding number virtual voice ports to the particular NTD. The DPU may be configured to include in communications to a particular NTD a port indication identifying a particular ATA module of the NTD for receiving said communications. Each NTD may be configured to include in communications to the DPU a virtual voice port indication identifying a particular virtual voice port for receiving said communications.

According to still yet another aspect of the present invention, there is provided a Network Termination Device (NTD) configured for coupling to a Distribution Point Unit (DPU), for example the DPU of the above aspect, via an electrical line, the NTD configured to communicate with the DPU via the electrical line, wherein the NTD is configured to receive voice configuration messages from the DPU, and wherein the NTD is controllably interfaced with an Analog Telephone Adaptor (ATA) such that the NTD communicates received voice configuration messages to the ATA, thereby causing the ATA module to be configured according to the voice configuration message.

### BRIEF DESCRIPTION OF THE DRAWINGS

One or more embodiments of the present invention will hereinafter be described with reference to the accompanying Figures, in which:

FIG. 1 shows an example of a known FTTH or FTTP prior art topology.

FIG. 2 shows a voice communication system within an FTTdp topology according to an embodiment.

FIG. 3 shows example arrangements of ATA module and NTD.

FIG. 4 shows a schematic example of a DPU.

FIG. 5 shows a method for providing voice configuration data to an ATA module controlled by a NTD via the DPU, according to an embodiment.

FIG. 6 shows a complementary method to that of FIG. 5 implemented by an NTD, according to an embodiment.

FIGS. 7A and 7B show methods for maintaining a voice channel, according to two embodiments.

### DESCRIPTION OF PREFERRED EMBODIMENT(S)

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

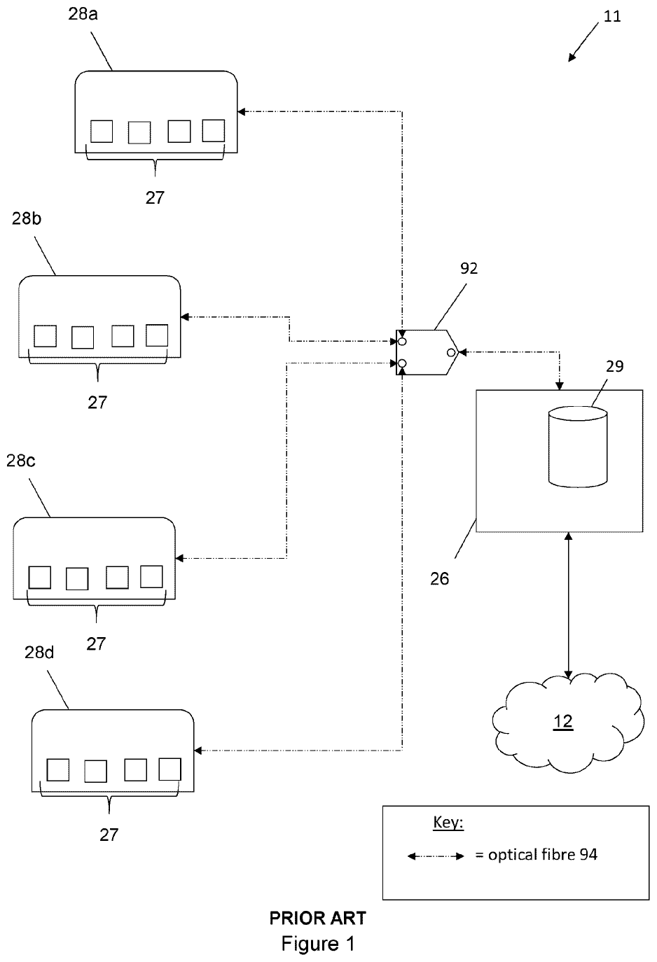

As shown in FIG. 1, Fibre to the Home (FTTH) (also known as Fibre to the Premises (FTTP)) networks 11 are known in the art in which Analog Telephone Adaptors (ATA) 20 are utilised to provide telephone services. The telephone services are provided using a digital connection over a packet network 12, which typically utilises the Internet, using a Session Initiation Protocol (SIP) connection service. The SIP connection service can be configured by an Element Management System (EMS) 29 designed for the particular FTTH network (herein, “FTTH EMS 29”). The FTTH EMS 29 is in digital data communication via an optical network (usually a Passive Optical Network (PON) such as GPON) to a plurality of Optical Network Termination units (ONT) 28 via a passive optical splitter 92. The ONTs 28 are each interfaced with a respective ATA module 20. The ATA module 20 is effectively the residence-side termination point for the SIP connection, and the ATA module 20 adapts or converts the digital voice data into a conventional analogue telephony signal (sometimes known as a “POTS”—Plain Old Telephone Service) on a standard telephone socket. A traditional analogue telephone can then be plugged into the telephone socket to provide voice services—a user can use the analogue telephone in a known manner, and the ATA module 20 converts this into digital voice data.

The FTTH EMS 29 is configured for communication with its controlled ONTs 28 according to an FTTH control protocol. Specifically, reference is made herein to the ONU Management Control Interface (OMCI) as the FTTH control protocol, although alternative control protocols can be utilised. The FTTH control protocol, such as OMCI, is typically a protocol for configuring, managing, and monitoring ONTs 28. For example, OMCI messages can be communicated from the FTTH EMS 29 to its controlled ONTs 28 in order to effect configuration changes. Also, ONTs 28 can be configured to communicate OMCI messages to the FTTH EMS 29 (e.g. responses and status updates).

According to an implementation of FTTH, an ONT 28 can comprise one or more voice ports 27—each voice port 27 typically comprising a physical interface, such as a jack, for connection to a telephone. Relevantly, the ONTs 28 are typically configured to advise (e.g. via OMCI messaging) the controlling FTTH EMS 29 of the number of voice ports 27 it has available for use. Therefore, for each ONT 28, the FTTH EMS 29 is configured to maintain a record of the number of voice ports 27 available and statuses thereof. Therefore, the FTTH EMS 29 is enabled to activate and configure specific voice ports 27 on the ONTs 28 by sending relevant OMCI messages. Each voice port 27 can therefore be configured differently—for example, associated with different phone numbers and/or configuration details. The voice ports 27 can be configured with SIP configuration data—however, actual voice data is communicated according to a specific VolP protocol (which can be defined in the SIP configuration data). That is, SIP creates a voice session (a voice channel may correspond to a voice session) whereas the VoIP protocol defines the actual digital transmission of voice data. Embodiments herein described are with respect to signalling and control using the SIP protocol; however, other signalling protocols can be substituted where applicable.

FIG. 1 therefore shows known configurations for providing voice services in FTTH between an Optical Line Terminal (OLT) 26 and an ONT 28. The voice services are configured and managed by the FTTH EMS 29 implemented at the OLT 26—the FTTH EMS 29 effectively communicates configuration instructions to the ATA modules 20 of the OLTs 26, thereby causing each of the ATA modules 20 to form a terminating end of a voice channel. Herein, an ATA module 20 is described as “one end” of a “voice channel”—that is, it terminates a digital voice channel. The ATA module 20 effects termination of the digital voice channel by being configured with particular voice configuration data. Another end of the voice channel can correspond to a voice server (not shown), which can be directly controllable by the FTTH EMS 29. This voice server itself can interface with other telephone exchanges.

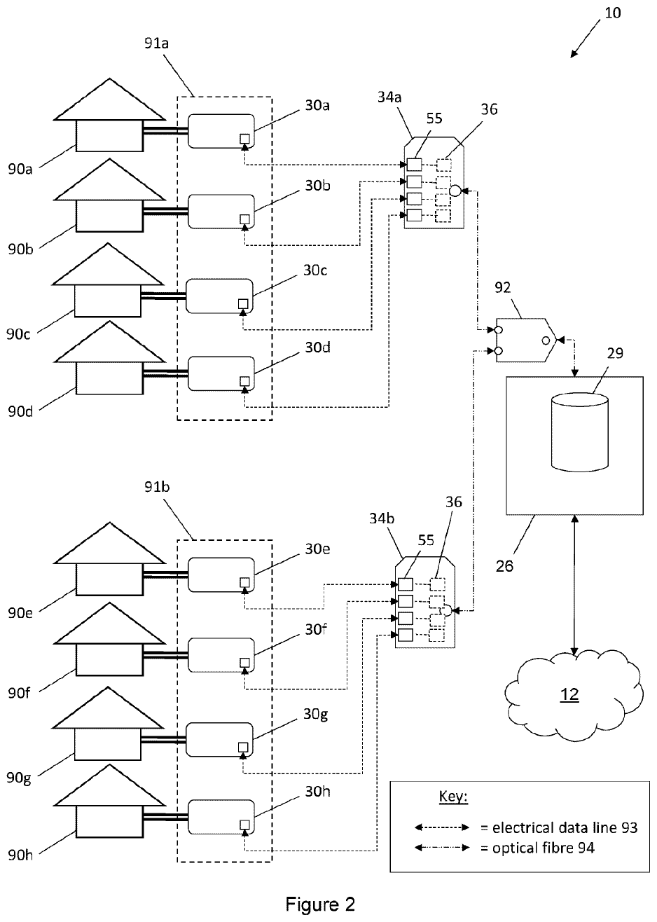

FIG. 2 shows a voice communication system (“system”) 10 according to an embodiment. The system 10 is based on a Fibre to the Distribution Point (FTTdp) broadband architecture. In FTTdp, a fibre optic connection 94 is provided, originating at an OLT 26 but terminating at a Distribution Point Unit (DPU) 34, which is not the end-point of the broadband network (e.g., it is not located at a particular residence 90). From the DPU 34, the final distance to the residence 90 is typically completed using copper wire and a corresponding electrical data communication standard. An advantage of such FTTdp topologies is that existing copper wire is utilised—for example, there is no requirement to enter or modify an existing residence to implement FTTdp. FTTdp encompasses several different topologies defined by the distance between the DPU 34 and the residences. In some implementations of FTTdp, the distance is small, e.g. <20 metres (referred to, within the context of the Australia NBN rollout, as Fibre to the Curb (FTTC)), whereas in other implementations, the distances are much larger, e.g. up to around 5 km (referred to, within the context of the Australia NBN rollout, as Fibre to the Node (FTTN)). For the present disclosure, it is assumed the FTTdp is a FTTC-like topology.

Several residences 90 (90a to 90h) are shown, each associated with a unique Network Termination Device (NTD) 30 (i.e. there is one NTD 30 for each residence 90, NTDs 30a to 30h associate respectively with residences 90 a to 90h). The term “residence” here is not intended to be limiting—the NTDs 30 represent data endpoints within the context of FTTdp 16, which may be associated with any particular place. For example, an NTD 30 could be associated with a business. Additionally, a particular residence 90 could be associated with multiple NTDs 30.

For illustrative purposes, the system 10 is shown with the NTDs 30 grouped into two groups 91a and 91b, such that NTDs 30a-30d are associated with group 91a and NTDs 30e-30h are associated with group 91b. Each group 91 is uniquely associated with a DPU 34 (i.e. group 91a is associated with DPU 34a and group 91b is associated with DPU 34b). The NTDs 30 of a particular group of residences 90 are in direct data communication with the DPU 34 associated with the group 91 via an electrical data line 93. Assumed herein, the direct data communication is via a wired DSL connection (for example, VDSL (ITU G.993.1) or VDSL2 (ITU-T G.993.2), G. Fast (ITU-T G.9700 and G.9701)), or (G.mgfast ITU-T SG15 Q4), although, more generally, the direct data communication is an electrical data connection (it can be, for example, an Ethernet connection). An electrical data line 93 can comprise a copper twisted-pair. That is, the data communication is direct in that each NTD 30 is directly addressable by its associated DPU 34 (e.g. the DSL signal originates and terminates at the DPU 34/NTD 30 via a direct wired connection—usually, there is no intervening hardware).

Each DPU 34 is configured to receive data from a network 12 via a fibre optic connection 94. The network 12 typically comprises the Internet as FTTdp is typically utilised to provide Internet services to residences 90. According to the embodiment shown, the fibre optic connections 94 are part of a Passive Optical Network (PON), and therefore, each fibre optic connection 94a, 94b connects its respective DPU 34a, 34b to an optical splitter 92. The optical splitter 92 itself is connected, via fibre optic connection 94c, to the OLT 26. It is the OLT 26 which facilitates the data connection to the network 12 for the DPUs 34 (and, therefore, the NTDs 30).

The FTTH topology as illustrated in FIG. 1 can be contrasted with the FTTdp topology shown in FIG. 2. An FTTH EMS 29 implemented at the OLT 26 in FIG. 1 can directly address and control its ONTs 28 (e.g. using OMCI). As discussed already, existing ONTs 28 are also configured to receive instructions directly from the managing FTTH EMS 29 and to communicate responses directly to the FTTH EMS 29. However, generally, FTTH EMS 29 systems (as known in the art) are not configured for direct communication with NTDs 30 of a FTTdp 16 topology—the DPUs 34 effectively conceal the NTDs 30 from the FTTH EMS 29. Although it may be possible to implement a FTTdp configured Element Management System (EMS) (herein, FTTdp EMS, not shown) in parallel to the FTTH EMS 39, in practice, this requires further computing resources to be implemented by the network operator and, correspondingly, increased cost and complexity. That is, the network operator essentially is required to operate two independent systems. Even if the FTTH EMS 29 and FTTdp EMS are integrated into a single software package, ultimately, there are still two different management systems in operation.

In view of this, embodiments of the invention may be advantageously applicable to an FTTH EMS 29 which is not configured for directly communicating with an ATA module 20 associated with a residence 90 within a FTTdp topology. That is, an FTTH EMS 29 may advantageously be utilised (without modification) to configure ATA modules 20 of a FTTdp network, despite the absence of (FTTH) ONTs 28.

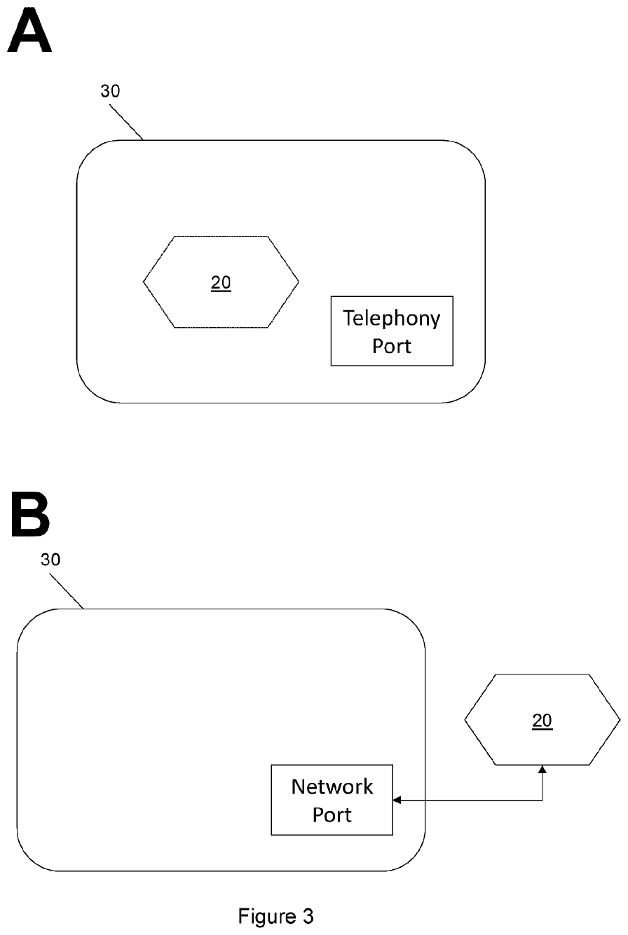

FIG. 3 schematically shows an NTD 30 interfaced with an ATA module 20 according to different embodiments. In one possible embodiment (A), the ATA module 20 is implemented as a logical function of the NTD 30, so that the digital telephone service effectively terminates at a physical analogue socket on the NTD 30—this physical socket provides an analogue interface to which a regular analogue telephone can be connected. Advantageously, this arrangement may simplify management of voice services by physically associating the ATA module 20 with the NTD 30. In another possible embodiment (B), the ATA module 20 is implemented as a separate physical device to the NTD 30 but is directly addressable by the NTD 30; the NTD 30 is configured to communicate with the ATA module 20 as if it is controlled by the NTD 30. In this latter embodiment, the ATA module 20 may be implemented in a router or as a standalone device. An advantage of this arrangement may be that existing NTDs 30 can be updated with new firmware to provide the functionality herein described—for example, said firmware causing the NTD 30 to associate itself with a particular interfaced ATA module 20.

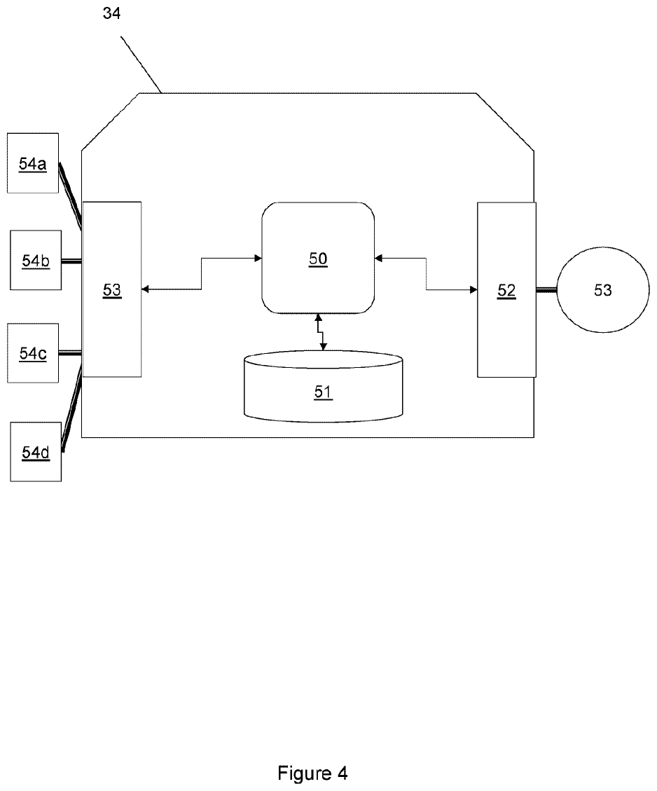

FIG. 4 shows a DPU 34 according to an embodiment. The DPU 34 is configured to provide known DPU functionality; to this end, the DPU 34 comprises a processor 50 interfaced with a memory 51, an optical network controller 52, and a DSL network controller 53. In an implementation, two or more of the processor 50, memory 51, optical network controller 52, and DSL network controller 53 are implemented within a multifunction chip. More generally, and typically, the processor 50 comprises a single-or multi-core CPU. The memory 51 typically comprises volatile and non-volatile memories. In an embodiment, at least some of the functionality of the DPU 34 is provided by a field-programmable gate array (FPGA). As mentioned above, for convenience, reference is made to DSL for electrical line communication protocols; however, the electrical communication can correspond to other protocols (such as Ethernet). The optical network controller 52 comprises an optical port 53 configured to couple to an optical line for optical data communication with the OLT 26. The DSL network controller 54 comprises one or more DSL ports 55 (four are shown) each configured to be coupled to a unique electrical data line 93 (as shown, for example, in FIG. 2). The solutions herein described are particularly suitable to DPUs 34 comprising a plurality of DSL ports 55 as there is a one-to-many relationship between the optical port 53 and the DSL ports 55.

According to an embodiment, the DPU 34 is effectively further configured to appear as an ONT 28 of a FTTH topology-for example, the DPU 34 is configured to receive and send OMCI defined messages. The DPU 34, according to this embodiment, is configured to associate one or more of its physical DSL ports 55 with “virtual” voice ports 36. For example, the DPU 34 informs the FTTH EMS 29 that it has a configurable “voice port” (according to OMCI) for each virtual voice port 36—the FTTH EMS 29 is not made aware that the voice ports are in fact each a virtual voice port 36 associated with a DSL port 55. The virtual voice ports 36 are therefore stored in the memory 51 of the DPU 34 such that, when an OMCI communication is received addressing a particular voice port, the DPU 34 controller is enabled to identify the corresponding virtual voice port 36 and therefore the corresponding DSL port 55.

In an embodiment, the DPU 34 is preconfigured such that each DSL port 55 is associated with a particular virtual voice port 36 (e.g. stored in a non-overwritable portion of memory 51), e.g. each DSL port 55 is pre-mapped to a particular virtual voice port 36. Since each virtual voice port 36 is itself represented as a particular voice port of an ONT 28 according to the OMCI protocol, effectively each DSL port 55 is permanently associated with a particular OMCI voice port. In another embodiment, the DPU 34 is configured to dynamically assign a mapping between virtual voice port 36 and DSL port 55. In this embodiment, the mapping can be made on an as-needed basis; for example, the controller 54 can be configured to identify a newly added connection to a NTD 30 at a particular DSL port 55 and to assign a next available virtual voice port 36 according to a sequence (e.g. if each virtual voice port 36 is numbered consecutively, the next free virtual voice port 36 in the sequence is mapped). Alternatively, a randomly selected one of the remaining virtual voice ports 36 can be selected. In a case where the assignment is according to a sequence, said sequence can be a repeating sequence (e.g. if a last numbered voice port 36 is unavailable, the sequence returns to a first numbered voice port 36).

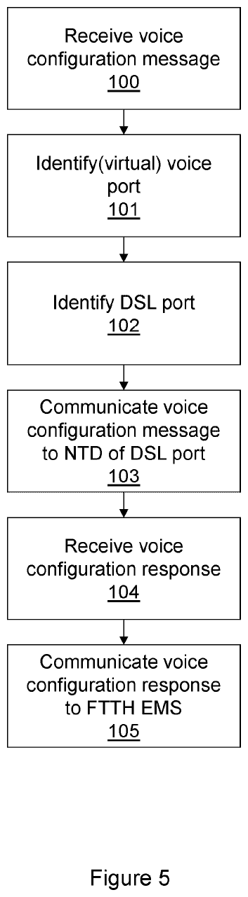

A method for providing voice configuration data to an ATA module 20 controlled by a NTD 30, according to an embodiment, is shown in FIG. 5. The method is applicable where a FTTH EMS 29 is enabled to communicate via OMCI with a DPU 34 (which, as discussed above, appears to the EMS 29 as a ONT 28).

At step 100, the DPU 34 receives a voice configuration message from the FTTH EMS 29 (e.g. SIP configuration data communicated using the OMCI protocol)—this information is suitable for use by an ATA module 20 to initiate its side of a voice channel. The DPU 34 is typically also configured to determine that the voice configuration data comprises address data indicating that the particular DPU 34 is the intended recipient of the voice configuration message. This is because the DPU 34 is typically a termination point of a PON, and therefore, is receiving data communications for not just itself but all termination points sharing the same optical splitter 92.

At step 101, the DPU 34 identifies a virtual voice port 36 associated with the voice configuration message—i.e. a voice port indicated as part of, or in associated with, the voice configuration message. At step 102, the DPU 34 identifies a corresponding DSL port 55—as the voice configuration message is effectively addressed to a virtual voice port 36 the DPU 34 is configured to identify the appropriate DSL port 55 from the mapping stored in its memory 51.

At step 103, the DPU 34 communicates the voice configuration message via the determined DSL port 55 to the NTD 30 that is in direct data communication with the identified DSL port 55. In an embodiment, the DPU 34 simply passes the received voice configuration message to the NTD 30 without modification—i.e. the voice configuration message remains consistent with the OMCI protocol. In another embodiment, the DPU 34 converts the voice configuration message into another format (which may entail the addition or removal of some data—relevantly, the conversion should retain sufficient information to enable the receiving ATA module 20 to configure itself to set up its end of the voice channel). For example, a proprietary format can be utilised rather than a publicly defined format—this may advantageously provide improved security between the DPU 34 and NTD 30 (for example, to avoid or at least reduce the ease of a corrupted NTD 30 communicating adverse information upstream). However, a different (i.e. non-OMCI) publicly defined format can be utilised.

In the present embodiment, it is assumed that the NTD 30 will communicate a response subsequent to step 103. Therefore, at step 104, the DPU 34 receives a voice configuration response from the NTD 30. Again, the voice configuration response can be in the OMCI format, a proprietary format, or a different publicly defined format). In the latter two cases, the DPU 34 is configured to convert the voice configuration response into the format utilised by the FTTH EMS 26 (e.g. OMCI).

At step 105, the DPU 34 communicates the voice configuration response to the FTTH EMS 29. Relevantly, the DPU 34 also communicates with the voice configuration response information indicating a voice port according to OMCI associated with the DSL port 55 via the corresponding virtual voice port 36.

According to the method of FIG. 5, the ATA module 20 associated with the receiving NTD 30 is provided with necessary SIP configuration data to set up its side of a voice channel (this could be the voice configuration message itself or derived therefrom). Therefore, the FTTH EMS 29 is not aware that the NTD 30 is involved-from its perspective, the DPU 34 is treated as an ONT 28 with multiple voice ports that can be configured.

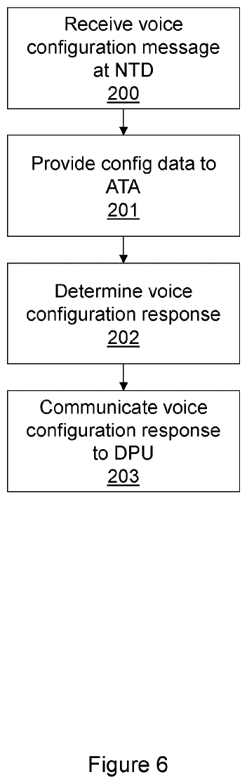

FIG. 6 shows a complementary method to that of FIG. 5, according to an embodiment. Herein, at step 200, an NTD 30 receives a voice configuration message from its connected DPU 34 (e.g. sent at step 103). The NTD 30 is not required to be aware that the voice configuration message was associated with a particular voice port under OMCI. It is merely required, at step 201, to provide SIP configuration data (which could correspond to the voice configuration message or could be derived from the voice configuration message) to its interfaced ATA module 20. In a case where the ATA module 20 is a logical function of the NTD 30, the ATA module 20 is able to read the SIP configuration data from a shared memory. In a case where the ATA module 20 is physically separate to the NTD 30, the NTD 30 communicates the SIP configuration data to the ATA module 20.

At step 202, the NTD 30 determines a voice configuration response—typically, this will comprise data generated by the ATA module 20, for example, indicating a success or failure to set up its end of the voice channel. The NTD 30 then communicates the voice configuration response to the DPU 34 at step 203.

Therefore, the methods of FIGS. 5 and 6 can be combined to effectively create a voice channel terminating at the particular ATA module 20. In the event of an error, further repetitions of these methods can occur—for example, the FTTH EMS 39 can send further voice configuration message(s) subsequent to receiving the voice configuration response.

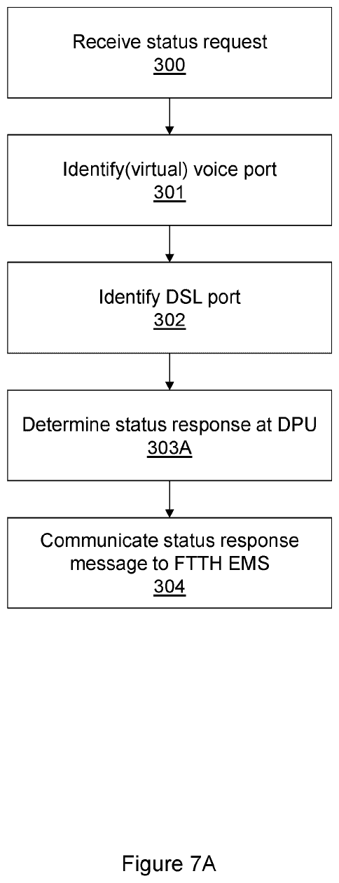

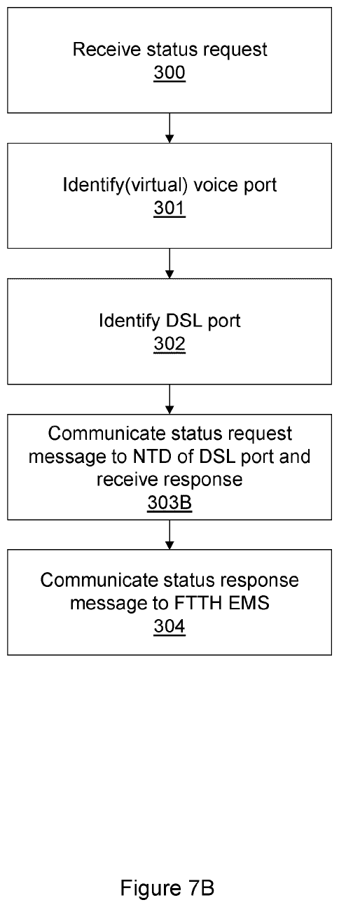

FIGS. 7A and 7B show two related methods of maintaining the voice channel, according to embodiments. The methods relate to messages communicated between the FTTH EMS 29 and an ATA module 20. For example, the SIP protocol allows for various different instances of status information to be communicated, for example including one or more of: hook state; status of the VolP session; SIP client addressing such as IP address, gateway address, MAC address, and network mask; SIP status (e.g. status of the ATA module 20); selected VoIP codec; emergency call status; RTP performance monitoring history data; SIP agent performance monitoring history data; and SIP call initiation performance monitoring history data.

Common to both embodiments, at step 300, the DPU 34 receives a status request message from the FTTH EMS 29. As with the method of FIG. 5, the DPU 34 appears as an ONT 28 with multiple voice ports—therefore, the status request message is accompanied by a voice port identifier. At step 301, the DPU 34 identifies a voice port associated with the status request message. At step 302, the DPU 34 identifies a corresponding DSL port 55—the voice data correlates with a virtual voice port 36 and the DPU 34 is configured to identify the appropriate DSL port 55 from the mapping stored in its memory 51.

In the embodiment shown in FIG. 7A, the DPU 34 is configured to maintain in its memory 51 status information about previously configured ATA modules 20. This is achieved by step 303A, in which the DPU 34 polls its connected NTDs 30 by sending status update request messages, on occasion (for example, according to a predefined period), to the NTDs 30 having configured ATA modules 20 and receives responses—which are typically derived from a response generated by the ATA modules 20. These responses are stored in the memory 51 for later access.

In the alternative embodiment shown in FIG. 7B, in response to receiving a status request message, the DPU 34 is configured to communicate a status request message to the NTD 30 associated with the corresponding identified DSL port 55 and to receive a status response, at step 303B.

The embodiments of FIGS. 7A and 7B can be combined—that is, some status items are polled, and responses stored in memory 51, whereas others are obtained as needed. Additionally, or alternatively, the DPU 34 is configured to determine one or more relevant statuses of its connected ATA modules 20 without communicating request messages—for example, via a monitoring process of communications directed towards, and originating from, the connected ATA modules 20.

In either embodiment, at step 304, the DPU 34 communicates the status response to the FTTH EMS 29. Relevantly, the DPU 34 also communicates data indicating the voice port associated with the DSL port 55.

Embodiments disclosed herein advantageously provide a DPU 34 configured to effectively act as a proxy for, typically, a plurality of ONTs 28. The DPU 34 thereby enables an FTTH EMS 29 to issue control and maintain instructions indirectly to the ATA modules 20 of its connected NTDs 30 without requiring the FTTH EMS 29 to be “aware” of the FTTdp topology, and therefore, the presence of the NTDs 30. Instead, the FTTH EMS 29 treats the DPU 34 as an ONT 28 with multiple voice ports. Each voice port can be, within the FTTH EMS 29, labelled or otherwise associated with a particular one of the residences 90, such that an operator is enabled to identify a particular residence 90 for each apparent voice port of the DPU 34.

According to a variation, an embodiment includes enabling NTDs 30 be interfaced with one or more ATA modules 20. Here, each ATA module 20 is representative of a uniquely addressable telephony port. Therefore, each ATA module 20 can be embodied in the same physical hardware or in different hardware (or a combination).

Accordingly, in this embodiment, the DPU 34 is enabled to map one or more virtual voice ports 36 to a particular DSL port 55. Similarly, the FTTH EMS 29 is enabled to provide an interface such that an operator is made aware that a particular collection of voice ports of DPU 34, represented in the FTTH EMS 29 as an ONT 28 with multiple voice ports, relate to a single residence 90 (in reality, that is, related to a single NTD 30).

In one implementation, the system 10 is preconfigured with one or more NTDs 30 known to have multiple ATA modules 20. Such pre-configuration can include, for example, preconfiguring the or each DPU 34. This may be applicable, for example, where every NTD 30 comprises the same number of interfaced ATA modules 20 (i.e. more than one ATA module 20), such that the DPU 34 is preconfigured to assign groups of DSL ports 55 to the same NTD 30 is a consistent manner. In another implementation, NTDs 30 are configured to inform, via data communication, its connected DPU 34 of the number of ATA modules 20 to which is it interfaced. In response, the DPU 34 dynamically maps a required number of virtual voice ports 36 to the particular NTD 30.

In an implementation, the DPU 34 is configured to provide the FTTH EMS 29 with data indicating that a particular group of two or more voice ports relate to the same residence 90. In another implementation, the FTTH EMS 29 is preconfigured to assume that the voice ports of the DPU 34 (appearing as an ONT 28) are arranged into groups, each group associated with a particular residence (e.g. this may be particularly suitable where every NTD 30 comprises the same number of interfaced ATA modules 20).

Once the mapping is established such that multiple virtual voice ports 36 are mapped to the same DSL port 55, the DPU 34 is generally configured to include in communications to the particular NTD 30 a port indication—that is, information enabling the NTD 30 to determine which of its interfaced ATA modules 20 is the intended target of the particular communications. Similarly, an NTD 30 interfaced with multiple ATA modules 20 is generally configured to include in communications to the DPU 34 a virtual voice port indication—that is, information enabling the DPU 34 to determine which of its virtual voice ports 36 is the intended target of the particular communications.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A Distribution Point Unit (DPU) for facilitating communication of voice configuration data between an Element Management System configured for a Fibre to the Home network (FTTH EMS) and one or more ATA modules within a Fibre to the Distribution Point (FTTdp) network, the DPU comprising:
an optical network controller configured for data communication with an optical network via an optical port;
an electrical network controller comprising one or more of electrical ports for data communication, each electrical port configured for coupling to a separate electrical line, wherein said data communication, for each electrical port, is with a corresponding Network Termination Device (NTD) associated with the particular electrical line;
a memory; and
a processor operably interfaced with the optical network controller, the electrical network controller, and the memory, wherein the processor is configured to:
undertake data communication with the FTTH EMS via the optical port according to an FTTH control protocol, wherein the processor is configured to present, to the FTTH EMS, the DPU as an Optical Network Terminal (ONT) of a FTTH network, wherein the processor maintains in the memory one or more of virtual voice ports, wherein each virtual voice port is mappable to one of the electrical ports, and wherein the processor informs the FTTH EMS, via the FTTH control protocol, that it has a distinct voice port for each of its virtual voice ports;
maintain a mapping between the virtual voice ports and the electrical ports;
receive a voice configuration message and a corresponding voice port identifier according to the FTTH control protocol and identify the corresponding virtual voice port;
determine a particular one of the electrical ports associated with the identified virtual voice port according to the mapping; and
communicate the voice configuration message to the NTD associated with the determined electrical port.

2. A DPU as claimed in claim 1, comprising a plurality of electrical ports and a plurality of virtual voice ports.

3. A DPU as claimed in claim 1 or claim 2, wherein the optical network is a Passive Optical Network (PON).

4. A DPU as claimed in any one of claims 1 to 3, wherein the FTTH control protocol comprises the ONU Management Control Interface (OMCI).

5. A DPU as claimed in any one of claims 1 to 4, wherein each electrical port is configured for communicating with its associated NTD according to a Digital Subscriber Line protocol, such as VDSL, VDSL2, G.Fast, or G.mgfast.

6. A DPU as claimed in any one of claims 1 to 5, wherein the mapping between virtual voice ports and the electrical ports is predefined in memory.

7. A DPU as claimed in any one of claims 1 to 5, wherein the mapping is dynamically updated such that a new mapping between a particular virtual voice port and a particular electrical port is made when required, such as when a new NTD is connected to said particular electrical port.

8. A DPU as claimed in any one of claims 1 to 7, wherein the mapping provides a one-to-one relationship between the virtual voice port(s) and the electrical port(s).

9. A DPU as claimed in any one of claims 1 to 7, wherein the DPU is enabled to map one or more virtual voice ports to the, or each, electrical port.

10. A DPU as claimed in any one of claims 1 to 9, wherein the processor is further configured to convert the voice configuration message to another protocol, different to the FTTH control protocol, before communicating the voice configuration message to the associated NTD.

11. A DPU as claimed in any one of claims 1 to 10, wherein the voice configuration message comprises Session Initiation Protocol (SIP) information.

12. A DPU as claimed in any one of claims 1 to 11, wherein the processor is further configured to:
receive a voice configuration response from the NTD; and
communicate the voice configuration response to the FTTH EMS according to the FTTH control protocol with data identifying a voice port corresponding to the virtual voice port mapped to the electrical port associated with the particular NTD.

13. A DPU as claimed in any one of claims 1 to 12, wherein the processor is further configured to:
receive a status request message and a corresponding voice port identifier from the FTTH EMS and identify the corresponding virtual voice port;
determine a particular one of the electrical ports associated with the identified virtual voice port according to the mapping; and
communicate the status request message to the NTD associated with the determined electrical port.

14. A DPU as claimed in claim 13, wherein the processor is further configured to:
receive a status response message from an NTD to which a status request message has been communicated, the status response message in response to the status request message; and
communicate the status response message to the FTTH EMS according to the FTTH control protocol with data identifying a voice port corresponding to the virtual voice port mapped to the electrical port associated with the particular NTD.

15. A network system comprising a DPU according to any one of claims 1 to 14, and further comprising:
one or more NTDs each coupled, via separate electrical lines, to a unique one of the electrical ports of the DPU.

16. A network system as claimed in claim 15, wherein each NTD is interfaced with at least one ATA module, and wherein each NTD is configured to:
provide received voice configuration messages to its interfaced at least one ATA modules, thereby causing the, or each, ATA module to be configured according to the voice configuration message.

17. A network system as claimed in claim 16, wherein each NTD is further configured to:
determine and communicate a status response message, based on information generated by the, or each, interfaced ATA module, in response to receiving a status request message.

18. A network system as claimed in any one of claims 15 to 17, wherein at least one NTD comprises: at least one ATA module as a logical component; and, a physical analogue telephony port for the, or each, ATA module.

19. A network system as claimed in any one of claims 15 to 18, where each NTD is interfaced with one ATA module.

20. A network system as claimed in any one of claims 15 to 18 when dependent on claim 9, wherein each NTD is interfaced with a plurality of ATA modules, such that each NTD is interfaced with the same number of ATA modules, and wherein the DPU is preconfigured such as to associate groupings of virtual voice ports with each NTD, each group comprising a number of virtual voice ports equal to the number of ATA modules interfaced with each NTD.

21. A network system as claimed in any one of claims 15 to 18 when dependent on claim 9, wherein each NTD is interfaced with one or more ATA modules and is configured to inform the DPU of its number of interfaced ATA modules, and wherein the DPU is configured to, in response, map a grouping comprising a corresponding number virtual voice ports to the particular NTD.

22. A network system as claimed in either one of claims 20 and 21, wherein the DPU is configured to include in communications to a particular NTD a port indication identifying a particular ATA module of the NTD for receiving said communications.

23. A network system as claimed in any one of claims 20 to 22, wherein each NTD is configured to include in communications to the DPU a virtual voice port indication identifying a particular virtual voice port for receiving said communications.

24. An aggregate network system comprising a plurality of network systems, each as claimed in any one of claims 15 to 23, wherein the DPUs of each network system are in data communication with the same FTTH EMS.

25. A network system as claimed in any one of claims 15 to 23 or an aggregate network system as claimed in claim 24, further comprising the FTTH EMS.

26. A method for facilitating communication of voice configuration data between an Element Management System configured for a Fibre to the Home network (FTTH EMS) and one or more ATA modules within a Fibre to the Distribution Point (FTTdp) network, the method comprising:
undertaking data communication with the FTTH EMS via an optical data line according to an FTTH control protocol, including presenting, to the FTTH EMS, a Distribution Point Unit (DPU) as an Optical Network Terminal (ONT) of the FTTH network,
maintaining one or more of virtual voice ports, wherein each virtual voice port is mappable to one of one or more of electrical ports of the DPU, including informing the FTTH EMS, via the FTTH control protocol, that the DPU has a distinct voice port for each of its virtual voice ports;
maintaining a mapping between the virtual ports and the electrical ports;
receiving a voice configuration message and a corresponding voice port identifier according to the FTTH control protocol at the DPU and identifying the corresponding virtual voice port;
determining a particular one of the electrical ports associated with the identified virtual voice port according to the mapping; and
communicating the voice configuration message to an Network Termination Device (NTD) associated with the determined electrical port.

27. A method as claimed in claim 26, wherein the DPU comprises a plurality of electrical ports and the method comprises maintaining a plurality of virtual voice ports.

28. A method as claimed in claim 26 or claim 27, wherein the optical network is a Passive Optical Network (PON).

29. A method as claimed in any one of claims 26 to 28, wherein the FTTH control protocol comprises the ONU Management Control Interface (OMCI).

30. A method as claimed in any one of claims 26 to 29, wherein each electrical port is configured for communicating with its associated NTD according to a Digital Subscriber Line protocol, such as VDSL, VDSL2, G.Fast, or G.mgfast.

31. A method as claimed in any one of claims 26 to 30, wherein the mapping between virtual voice ports and the electrical ports is predefined in a memory of the DPU.

32. A method as claimed in any one of claims 26 to 31, wherein the mapping is dynamically updated such that a new mapping between a particular virtual voice port and a particular electrical port is made when required, such as when a new NTD is connected to said particular electrical port.

33. A method as claimed in any one of claims 26 to 32, wherein the mapping provides a one-to-one relationship between the virtual voice port(s) and the electrical port(s).

34. A method as claimed in any one of claims 26 to 32, wherein the DPU is enabled to map one or more virtual voice ports to the, or each, electrical port.

35. A method as claimed in any one of claims 26 to 34, wherein the voice configuration message is communicated to the associated NTD using the FTTH control protocol.

36. A method as claimed in any one of claims 26 to 35, further comprising converting the voice configuration message to another protocol, different to the FTTH control protocol, before communicating the voice configuration message to the associated NTD.

37. A method as claimed in any one of claims 26 to 36, wherein the voice configuration message comprises Session Initiation Protocol (SIP) information.

38. A method as claimed in any one of claims 26 to 37, further comprising:
receiving, at the DPU, a voice configuration response from the NTD; and
communicating the voice configuration response to the FTTH EMS according to the FTTH control protocol with data identifying a voice port corresponding to the virtual voice port mapped to the electrical port associated with the particular NTD.

39. A method as claimed in any one of claims 26 to 38, further comprising the steps of:
receiving, at the DPU, a status request message and a corresponding voice port identifier from the FTTH EMS and identifying the corresponding virtual voice port;
determining a particular one of the electrical ports associated with the identified virtual voice port according to the mapping; and
communicating the status request message to a NTD associated with the determined electrical port.

40. A method as claimed in claim 39, further comprising the steps of:
receiving a status response message from an NTD to which a status request message has been communicated, the status response message in response to the status request message; and
communicating the status response message to the FTTH EMS according to the FTTH control protocol with data identifying a voice port corresponding to the virtual voice port mapped to the electrical port associated with the particular NTD.

41. A method as claimed in any one of claims 26 to 40, further comprising the step of:
coupling an NTD to at least one electrical port of the DPU.

42. A method as claimed in any one of claims 26 to 41, wherein each NTD is interfaced with at least one ATA module, and further comprising the step of:
providing, by an NTD, received voice configuration messages to its interfaced at least one ATA modules, thereby causing the, or each, ATA module to be configured according to the voice configuration message.

43. A method as claimed in claim 42, further comprising the step of:
at an NTD, determining and communicating a status response message, based on information generated by the, or each, interfaced ATA module, in response to receiving a status request message.

44. A method as claimed in any one of claims 26 to 43, wherein at least one NTD comprises: at least one ATA module as a logical component; and a physical analogue telephony port for the, or each, ATA module.

45. A method as claimed in any one of claims 42 to 44, where each NTD is interfaced with one ATA module.

46. A method as claimed in any one of claims 42 to 44 when dependent on claim 34, wherein each NTD is interfaced with a plurality of ATA modules, such that each NTD is interfaced with the same number of ATA modules, and wherein the DPU is preconfigured such as to associate groupings of virtual voice ports with each NTD, each group comprising a number of virtual voice ports equal to the number of ATA modules interfaced with each NTD.

47. A method as claimed in claim 42 to 44 when dependent on claim 34, wherein each NTD is interfaced with one or more ATA modules and further comprising the steps of:
at an NTD, informing the DPU of its number of interfaced ATA modules; and
in response, the DPU mapping a grouping comprising a corresponding number virtual voice ports to the particular NTD.

48. A method as claimed in either one of claims 46 and 47, wherein the DPU is configured to include in communications to a particular NTD a port indication identifying a particular ATA module of the NTD for receiving said communications.

49. A method as claimed in any one of claims 46 to 48, wherein each NTD is configured to include in communications to the DPU a virtual voice port indication identifying a particular virtual voice port for receiving said communications.

50. A Network Termination Device (NTD) configured for coupling to a Distribution Point Unit (DPU) via an electrical line, the NTD configured to communicate with the DPU via the electrical line, wherein the NTD is configured to receive voice configuration messages from the DPU, and wherein the NTD is controllably interfaced with an Analog Telephone Adaptor (ATA) such that the NTD communicates received voice configuration messages to the ATA, thereby causing the ATA module to be configured according to the voice configuration message.

51. A NTD as claimed in claim 50, configured for coupling to the DPU of any one of clams 1 to 14.
